(19) United States
(12) Patent Application Publication
(10) Pub. No.: US 2008/0272586 A1
(43) Pub. Date: Nov. 6, 2008

(54) MULTI-PART IDENTIFICATION LABELS

(75) Inventors: Robert Hick, Newberg, OR (US); Paul S. Maddox, Tualatin, OR (US); Guy Gladden, Washougal, WA (US)

Correspondence Address: Marger Johnson & McCollom PC - Leviton, 210 SW Morrison, Suite 400, Portland, OR, 97204, US

(73) Assignee: LEVITON MANUFACTURING CO., INC., Little Neck, NY (US)

(21) Appl. No.: 12/108,214

(22) Filed: Apr. 23, 2008

Related U.S. Application Data
(60) Provisional application No. 60/916,196, filed on May 4, 2007.

(51) Int. Cl. B42D 15/10; G09F 3/10; B42D 115/00

(52) U.S. Cl. 283/81; 40/638

(57) ABSTRACT

Information about an object such as its name, identification number, manufacture date, lot number, serial number or communication address is placed on each part of a multi-part label is affixed to the object so that at least one of the multiple parts can be detached and then affixed to another object, thus transferring the information to the second object. Applications include identifying computer equipment, electrical and electronic devices, construction fixtures such as luminaries, ballasts, light switches, electrical outlets, faucets and door locks; medicines, and bulk containers of liquids and gases.

### CLAIM OF PRIORITY

This application claims priority from U.S. Provisional Patent Application Ser. No. 60/916,196 entitled “Ballast Address Labeling” filed May 4, 2007, which is incorporated by reference.

### FIELD

The invention relates to device or product labeling. More specifically, the invention relates to methods and apparatus for creating and maintaining documents that incorporate information about individually-distinguishable objects.

### BACKGROUND

Goods manufacturing processes have historically tended towards the production of greater numbers of items, of decreasing degrees of variance from an ideal norm. Now, it is common for hundreds of thousands or millions of essentially identical units of a product to be produced. However, with the development of computer control, monitoring and communication technologies, it has become useful to be able to distinguish individual items that are otherwise identical. This is often accomplished by assigning each item a unique identifier, such as a serial number or Media Access Code (“MAC”) address. Assignment of unique identifiers may be done manually or automatically during the manufacturing process.

After production, these functionally identical, but individually identifiable and distinguishable, items may be sold and distributed to customers who put them to use or incorporate them into other systems. For these customers, it is often desired to track each item. For example, a lot of 1,000 Ethernet adapters (each with a unique MAC address) may be installed into a like number of computers. It may be necessary to keep records of which MAC address is associated with which computer so that network security and Internet Protocol (“IP”) address provisioning can be performed.

For computer-related items such as network adapters and hard disks, systems and procedures for collecting and storing serial numbers or other uniquely-identifying information are commonly available. Furthermore, once collected into an electronic database, the information can relatively easily be converted from one format to another as necessary to control subsequent activities. However, there are a number of applications where electronically-stored identification data fails to capture critical information about a distinguishable item. These applications call for an improved method of distributing, collecting, and managing the data.

### SUMMARY

A multi-part label has at least two parts, with each part bearing the same information about an object. One of the parts is adapted to be affixed to the object (or to the object's packaging), while another of the parts is removably attached. The removeable part may be detached from the multi-part label and then attached to another object to transfer the information about the first object onto the second object.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a fluorescent ballast with a multi-part label according to an embodiment of the invention attached to it.

FIG. 2 is a flow chart outlining the use of a multi-part label.

FIG. 3 shows several activities associated with the application and use of a multi-part label according to an embodiment of the invention.

### DETAILED DESCRIPTION

Embodiments of the invention permit physical records of functionally identical but individually distinguishable items to be created easily. A number of different applications will be described.

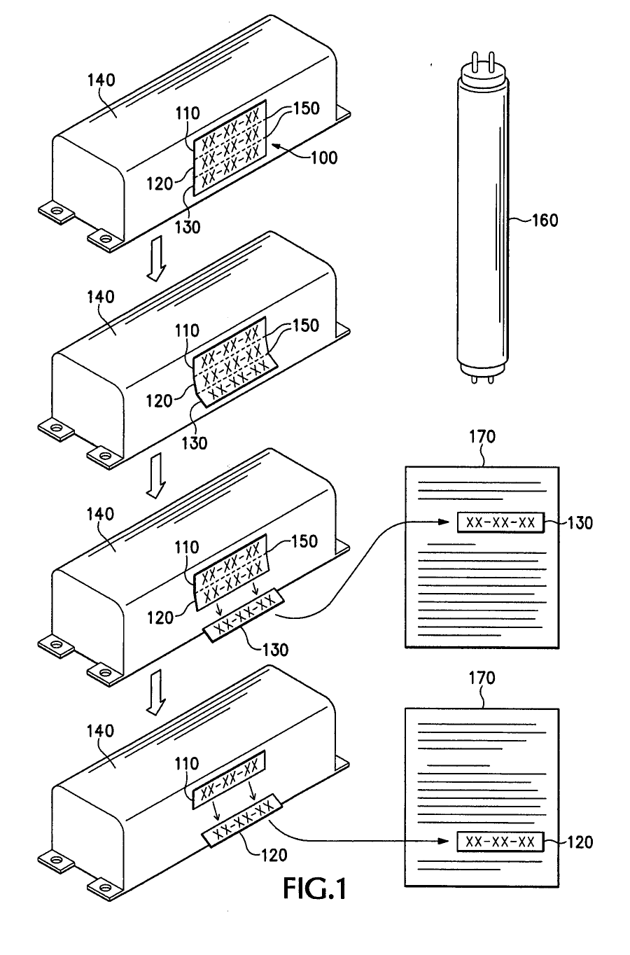

FIG. 1 shows a basic embodiment of the invention. Element 100 is a label displaying three copies 110, 120, 130 of identifying information for a device 140. One copy no is affixed to the device itself, while two copies 120, 130 are removeable. For example, label portion no may be attached to device 140 by an adhesive backing (not shown), while portions 120 and 130 may be separated by perforations 150. The perforated portions of the label can be detached from portion no and affixed to different physical records 170 to quickly transfer the identifying information to those physical records.

Device 140 in FIG. 1 may be, for example, a ballast for a fluorescent or gas-discharge lamp 160. Such ballasts are conventionally installed in (or near) a lighting fixture or luminaire, and are connected to a switched power source such as a 120 VAC system, and to one or more light bulbs or fluorescent lamps. There was no need to distinguish individual ballasts in the past, because each ballast and its lights were simply controlled by one or more specific physical switches (e.g., wall-mounted light switches). However, newer ballasts can also be controlled by logical messages transmitted over a communication channel from a computer system. Since the communication channel often interconnects a number of distinct ballasts, it is important that there be some method of identifying a specific ballast that is to be controlled. Typically, an addressing scheme is used: a control command (e.g., “Turn ON” or “Turn OFF”) is transmitted with the address of the ballast that should respond to the command. A unique address may be permanently assigned to each ballast. In this example, then, the unique address would be printed on each of the three portions of label 100. The address may be printed as human-readable digits and characters, as a machine-readable barcode, or both. Various portions of the label may contain different representations of the address. For example, one portion may contain a human-readable string; a second may contain a barcode; and a third may contain a radio-frequency identification (“RFID”) tag.

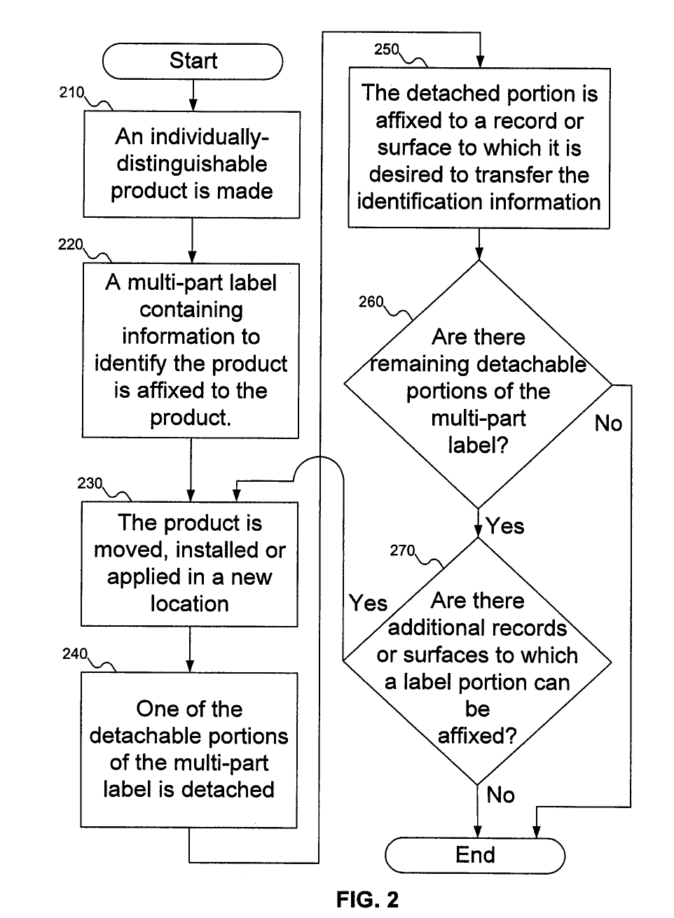

FIG. 2 outlines a method of using a multi-part label like the one shown in FIG. 1. An individually-distinguishable product is made (210) and a multi-part label containing information to identify the product is affixed to the product (220). The multi-part label has at least one portion adapted to remain permanently attached to the product, and at least one portion adapted to be detached from the product. Each portion contains information to identify the product, but each portion may contain that information in different forms.

The product is moved, installed or applied in a new location (230), and one of the at least one detachable portions of the multi-part label is detached (240). The detached portion is affixed to a record or surface to which it is desired to transfer the identification information (250). At step 260, it is determined whether there are additional detachable portions of the multi-part label. If it is determined that there are remaining detachable portions of the multi-part label, then at step 270, it is determined whether there are additional records or surfaces to which a remaining portion of the multi-part label can be affixed. In other words, any one of operations 230, 240 and 250 may be repeated for each such remaining portion.

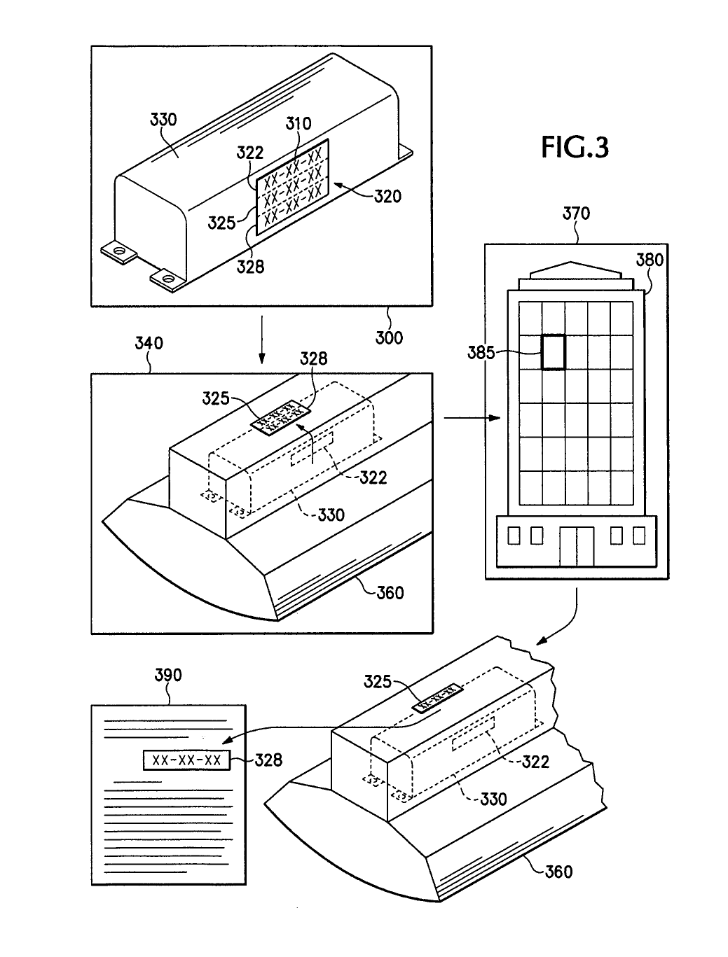

FIG. 3 shows a pictorial sequence of events in the manufacturing and use of a gas discharge lamp ballast such as that shown in FIG. 1. During or prior to manufacture, a ballast (330) may be assigned a unique serial number or address (310) at the location (300) where the ballast (330) is manufactured, or at some other predefined location (not shown) prior to manufacturing the ballast (330). This address may be printed on three parts 322, 325, and 328 of a multi-part label (320) and affixed to the ballast (330), at least one of the parts being removably attached. The ballast (330) may then be delivered to a luminaire manufacturer (340), which constructs a lamp assembly (i.e., luminaire 360) incorporating the ballast (330). The removeable parts (e.g., 325 and 328) of the multi-part label are detached from the ballast and affixed to the luminaire (360).

The luminaire may be delivered to a construction site (370), where it is installed into a building (380) at a particular location (385) in the building (380). One of the removeable parts (e.g., 328) of the multi-part label attached to the luminaire may be removed from the fixture and affixed to a construction blueprint (390), so that the blueprint is annotated to identify the location (385) where the luminaire containing the ballast is installed. The annotated blueprint can subsequently be used to configure a centralized lighting control system that sends commands over a communication network to turn lights on and off.

The foregoing example shows how a multi-part identification label according to an embodiment of the invention permits information to be transferred from one physical location to another quickly and with little risk of error. The number of detachable copies of a label can be increased to accommodate an arbitrary number of physical records and objects to which the information is to be copied. Using “peel-and-stick” style detachable labels can simplify manufacturing and installation operations. A peel-and-stick label is typically attached by an adhesive to a smooth backing material, from which the label may be removed (“peeled off”) without damaging the label or adhesive (the adhesive stays attached to the label when it is removed from the backing material). The adhesive-backed label can then be affixed to another object.

Label adhesives may be permanent or reversible. Reversible adhesive-backed labels can be transferred from one surface to another so that fewer detachable copies of the label need be provided with the identified product.

Multi-part labels according to an embodiment of the invention may be useful for items besides individually identifiable and/or addressable gas discharge lamp ballasts. For example, light switches (wall switches), electric outlet sockets, occupancy sensors, light sensors and thermostats may all be provided with network communication facilities, and may be individually addressable. Keeping track of the location in a building where such devices are installed may be simplified by using labels as described above.

Door lock mechanisms (both mechanical and electronic) are further examples of functionally identical but individually distinguishable devices for which it is useful to maintain documentation. Consider the door locks installed in a hotel or office building: it is important to be able to determine what lock can be opened with what key. A multi-part label as described herein can be affixed to each lock (or its packaging), and the parts of the label used to annotate construction blueprints and similar records.

Information about other construction fixtures such as faucets, toilets, automatic heating, ventilation and air conditioning (“HVAC”) control devices, and the like can also be tracked using multi-part labels. Although many of these fixtures traditionally needed no special identification, modern building monitoring and automation systems rely on being able to interrogate and/or control such devices individually. Thus, addressing or similar information must be kept. Furthermore, documents correlating each device's address with its installed location must be created and maintained. Multi-part labels as described herein can simplify that task.

Yet another application for multi-part identification labels appears in pharmaceutical manufacturing and distribution. Bulk containers of pills or other medicaments can be labeled with a multi-part identification label bearing information such as the lot number or manufacture date. When the pills are dispensed by a pharmacist into a smaller prescription container, one of the multi-part labels can be detached and affixed to the smaller container. Another label can be affixed to a doctor's prescription kept on file at the pharmacy. This permits the original lot number and/or manufacture date of the medicine to be determined easily from any paperwork or prescription bottle. Similarly, bulk containers for liquids and gases can be labeled with composition, manufacture date or other information, and this information can be easily copied to other containers filled from the bulk container with little risk of mistake.

Several applications of the present invention have been described by reference to specific examples and in terms of particular implementations. However, those of skill in the art will recognize that multi-part identification labels can be used to propagate information from almost any physical object to which a label can be attached (including the packaging of an object that is too small to label directly) to almost any other physical object to which a label can be attached. Such variations and implementations are understood to be captured according to the following claims.

We claim:

1. A multi-part identification label comprising:
a first label part bearing information about an object; and
a second label part bearing the same information about the object, wherein
the first label part is to be affixed to the object; and
the second label part is attached to the first label part; and
the second label part is adapted to be detached from the first label part and affixed to a second, different object.

2. The multi-part identification label of claim 1, further comprising:
a third label part bearing the same information about the object, wherein
the third label part is attached to at least one of the first label part and the second label part; and
the third label part is adapted to be detached from the first label part and the second label part, and affixed to a third, different object.

3. The multi-part identification label of claim 1 wherein the second label part is a peel-and-stick label.

4. The multi-part identification label of claim 3 wherein an adhesive of the peel-and-stick label is reversible.

5. The multi-part identification label of claim 3 wherein an adhesive of the peel-and-stick label is permanent.

6. The multi-part identification label of claim 1 wherein the first label part presents the information in a human-readable form, and
the second label part presents the information in a machine-readable form.

7. The multi-part identification label of claim 6 wherein the second label part comprises at least one of a bar code and a radio-frequency identification (“RFID”) tag.

8. An assembly comprising:
an electrically-operated apparatus; and
a multi-part label attached to the apparatus, wherein
a first part of the multi-part label is attached to the apparatus and bears information about the apparatus; and
a second part of the multi-part label is removably attached to the apparatus and bears the information about the apparatus.

9. The assembly of claim 7 wherein the electrically-operated apparatus is a fluorescent lamp ballast.

10. The assembly of claim 7 wherein the information about the apparatus comprises a serial number of the apparatus.

11. The assembly of claim 7 wherein the information about the apparatus comprises a communication address of the apparatus.

12. The assembly of claim 7 wherein the electrically-operated apparatus is one of a wall switch, an electric socket, an occupancy sensor, a light sensor or a thermostat.

13. The assembly of claim 7 wherein the second part of the multi-part label is a peel-and-stick label.

14. The assembly of claim 7 wherein the information on the second part of the multi-part label is machine-readable.

15. The assembly of claim 7 wherein the information on the second part of the multi-part label is a bar code.

16. The assembly of claim 7 wherein the information on the second part of the multi-part label is a radio frequency identification (“RFID”) tag.

17. A method comprising:
installing a component into a system;
detaching a part of a multi-part label affixed to the component; and
attaching the part of the multi-part label to an object.

18. The method of claim 16 wherein the component is a fluorescent ballast, the system is a luminaire, and the object is the luminaire.

19. The method of claim 16 wherein the component is a luminaire, the system is a lighting system of a building, and the object is a blueprint of the building.

20. The method of claim 16 wherein the part of the multi-part label contains identification information to distinguish the component from a plurality of functionally-identical components.
